(19) United States
(12) Patent Application Publication
(10) Pub. No.: US 2014/0153365 A1
(43) Pub. Date: Jun. 5, 2014

(54) SYSTEM AND METHOD FOR PRODUCING LOCAL IMAGES OF SUBSURFACE TARGETS

(71) Applicant: Joseph Paul Stefani, San Francisco, CA (US)

(72) Inventor: Joseph Paul Stefani, San Francisco, CA (US)

(73) Assignee: Chevron U.S.A. Inc., San Ramon, CA (US)

(21) Appl. No.: 13/689,865

(22) Filed: Nov. 30, 2012

(51) Int. Cl. G01V 1/28

(52) U.S. Cl. CPC G01V 1/282
USPC 367/73

(57) ABSTRACT

Full wavefield images are produced for a target within a geologic volume of interest from which seismic information has been acquired. The images are generated by generating Green's functions for wavefields propagating from a location at or near the target to the surface without requiring imaging of the entire geologic volume of interest.

### FIELD

The disclosure relates to producing a full-wavefield image of a portion of a geologic volume of interest.

### BACKGROUND

Seismic modeling of geologic earth structure provides information for development of petroleum and mineral resources. Such modeling can be used to determine effects of different seismic acquisition and/or imaging schemes on the seismic illumination and/or the interpretability of the final image at a subsurface target of interest.

Many acquisition and imaging schemes are known. Such schemes tend to either be costly in terms of computing resources (e.g., processing, storage, etc.), or tend to provide marginal results with respect to seismic illumination and/or interpretability.

### SUMMARY

One aspect of the disclosure relates to a computer-implemented method of producing local images of a portion of a geologic volume of interest. The method comprises obtaining an earth model of the geologic volume of interest, the earth model having been generated based on seismic data acquired during one or more seismic measurements performed in accordance with one or more acquisition parameters; obtaining a source location in the geologic volume of interest, wherein a position of the source location in the geologic volume of interest is based on a position in the geologic volume of interest of a portion of the geologic volume of interest for which local images are to be generated; obtaining a set of receiver locations and a seismic source location in or on the geologic volume of interest, wherein positions of the receiver locations and the seismic source location are toward a surface of the geologic volume of interest from the source location; conducting synthetic seismic acquisition on the earth model that synthesizes a seismic source at the source location; determining, from the results of the synthetic seismic acquisition, a first set of Green's functions that describe the seismic wave field propagating from the source location to the set of receiver locations and the seismic source location.

Another aspect of the disclosure relates to a system configured to produce local images of a portion of a geologic volume of interest. The system comprising one or more processors configured to execute computer program modules. The computer program modules comprise an earth model module, a source location module, a measurement location module, a synthetic seismic module, and a Green's function module. The earth model module is configured to obtain an earth model of the geologic volume of interest, the earth model having been generated based on seismic data acquired during one or more seismic measurements performed in accordance with one or more acquisition parameters. The source location module is configured to obtain a source location in the geologic volume of interest, wherein a position of the source location in the geologic volume of interest is based on a position in the geologic volume of interest of a portion of the geologic volume of interest for which local images are to be generated. The measurement location module is configured to obtain a set of receiver locations and a seismic source location in or on the geologic volume of interest, wherein positions of the receiver locations and the seismic source location are toward a surface of the geologic volume of interest from the source location. The synthetic seismic module is configured to conduct synthetic seismic acquisition on the earth model that synthesizes a seismic source at the source location. The Green's function module is configured to determine, from the results of the synthetic seismic acquisition, a first set of Green's functions that describe the seismic wave field propagating from the source location to the set of receiver locations and the seismic source location.

Yet another aspect of the disclosure relates to Non-transient electronic storage media that stores computer readable instructions configured to cause one or more processors to perform a method of producing local images of a portion of a geologic volume of interest. The method comprises obtaining an earth model of the geologic volume of interest, the earth model having been generated based on seismic data acquired during one or more seismic measurements performed in accordance with one or more acquisition parameters; obtaining a source location in the geologic volume of interest, wherein a position of the source location in the geologic volume of interest is based on a position in the geologic volume of interest of a portion of the geologic volume of interest for which local images are to be generated; obtaining a set of receiver locations and a seismic source location in or on the geologic volume of interest, wherein positions of the receiver locations and the seismic source location are toward a surface of the geologic volume of interest from the source location; conducting synthetic seismic acquisition on the earth model that synthesizes a seismic source at the source location; and determining, from the results of the synthetic seismic acquisition, a first set of Green's functions that describe the seismic wave field propagating from the source location to the set of receiver locations and the seismic source location.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a method of producing local images of a portion of a geologic volume of interest.

FIG. 2 illustrates a set of traces through a geologic volume of interest from a source location to the surface.

FIG. 3 illustrates a method of generating an image of a portion of a geologic volume of interest.

FIG. 4 illustrates a system configured to produce local images of a portion of a geologic volume of interest.

### DETAILED DESCRIPTION

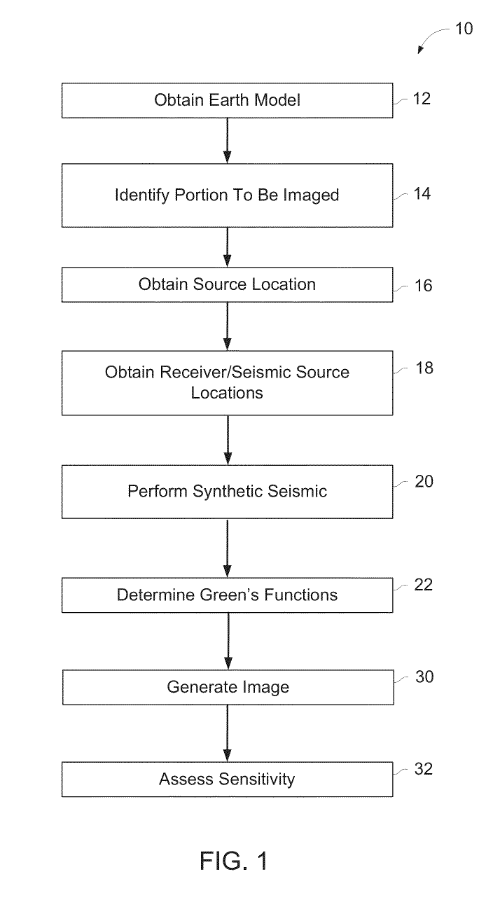

FIG. 1 illustrates a method 10 of producing local images of a portion of a geologic volume of interest. Method 10 facilitates production of local images of the geologic volume of interest using full seismic wavefields, while requiring exponentially less computational resources than conventional techniques. The local images may be targeted to a specific portion of the volume, rather than the entire volume, but this may be offset by markedly reduced cost of the local images with respect to a full image of the geologic volume of interest that implements full seismic wavefields.

At an operation 12, an earth model of the geologic volume of interest is obtained. The earth model is dependent on seismic data acquired during one or more seismic measurements. The one or more seismic measurements may have been performed in accordance with one or more acquisition parameters. The acquisition parameters may include, for example, one or more seismic source locations, one or more seismic receiver locations, a seismic wavelength, a seismic amplitude, and/or other parameters. Obtaining the earth model may include one or more of determining the earth model from the seismic data and/or other information, accessing a stored earth model, receiving an earth model over a network, receiving an earth model through a user interface, and/or obtaining an earth model in other ways.

At an operation 14, a portion of the geologic volume of interest to be imaged is identified. The portion of the geologic volume of interest may be specified based on input received through a user interface (e.g., a portion of interest to a user). A volume, area, dimension, and/or other size property of the portion may be determined based on an acquisition parameter (e.g., seismic wavelength). For example, the portion of the geologic volume of interest may be several wavelengths wide. There may be a constraint on this dimension, as resolution and/or accuracy of the described technique for obtaining an image of the portion of the geologic volume of interest is limited to a few (e.g., about 3-4) wavelengths. While the size of the portion of the geologic volume of interest for which an image is obtained may be less than the entire geologic volume of interest, the cost of obtaining the images in computational resources (e.g., processing, storage, etc.) is lower than typical wavefield-based imaging techniques.

At an operation 16, a source location in the geologic volume of interest is obtained. The source location is based on the portion identified at operation 14. The source location may be at or near the portion identified at operation 14. For example, the source location may be at or near a boundary of the portion that is furthest from the surface. Obtaining the source location may include one or more of determining a source location based on the portion identified at operation 14, receiving a source location over a network, receiving a source location from a user through a user interface, accessing a stored source location, and/or obtaining a source location in other ways.

At an operation 18, a set of locations in or on the geologic volume of interest significant in the seismic measurement(s) of the geologic volume of interest are obtained. These locations may include a set of receiver locations, one or more seismic source locations, and/or other locations. The set of receiver locations may correspond to receiver locations specified by the acquisition parameters associated with the earth model obtained at operation 12. For example, the set of receiver locations obtained at operation 18 may be the same as or similar to a set of receiver locations used to collect the seismic data from which the earth model is generated. Obtaining the set of receiver locations may include one or more of determining a set of receiver locations (e.g., based on acquisition parameters of the seismic data), receiving a set of receiver locations over a network, accessing a set of stored receiver locations, receiving a set of receiver locations through a user interface, and/or obtaining a set of receiver locations in other ways.

At an operation 20, synthetic seismic acquisition is performed on the earth model. The synthetic seismic acquisition synthesizes a seismic source disposed at the source location, and seismic receivers disposed at the set of receiver locations. The results of the synthetic seismic acquisition include synthetic seismic data captured at the receiver locations. The synthetic seismic acquisition may facilitate acquisition of seismic information related to seismic energy that travels from the source location to seismic source location(s) of the original seismic acquisition.

At an operation 22, Green's functions are determined that describe the synthetic seismic wavefield propagating from the source location during the synthetic seismic acquisition. This may include Green's functions for traces traveling from the source location to the set of receiver locations, to the seismic source location(s), and/or other locations. The Green's functions may include a first set of Green's functions determined from an earth model obtained at operation 12, and/or a second set of Green's functions determined from the earth model with a (potentially) less accurate velocity field. This second set of Green's functions may represent uncertainty in the knowledge of the portion of the geologic volume of interest.

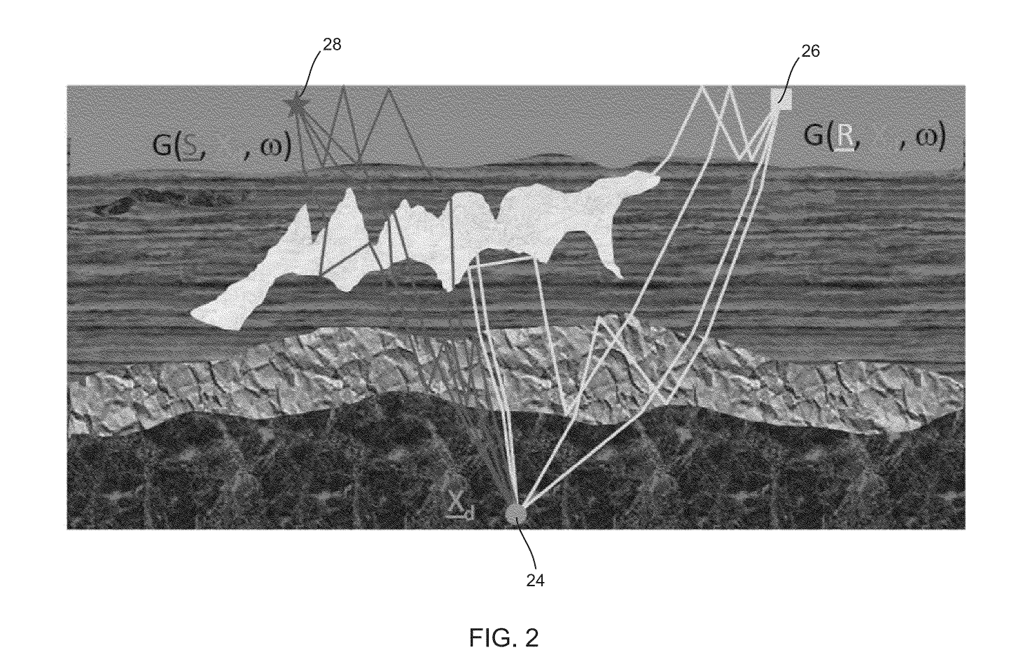

By way of illustration, FIG. 2 includes a depiction of seismic traces obtained from an operation similar to or the same as operation 20 (shown in FIG. 1). In FIG. 2, a synthetic source is placed at a source location 24. FIG. 2 depicts traces from source location 24 to a receiver location 26 and from source location 24 to a seismic source location 28. As can be seen in FIG. 2, the area around source location 24 for which Green's functions and/or traces are obtained may be somewhat limited. However, FIG. 2 further illustrates how method 10 may facilitate generation of images of the specific portion of the geologic volume of interest at or near source location 24 may enhance efficiency by not determining and/or considering seismic response outside of this area.

Returning to FIG. 1, at an operation 30, a local image of the specific portion of the geologic volume of interest are determined from the Green's functions generated at operation 22.

At an operation 32, the local image generated at operation 30 is analyzed to information related to acquisition effects on the local image, information related to effects of a velocity model of the geologic volume of interest on the local image, information related to shadow zones in the local image, and/or other information. The information related to acquisition effects on the local image may include a sensitivity to acquisition effects, and/or other information. The information related to effects of the velocity model of the geologic volume of interest may include a sensitivity to uncertainty in the velocity model, and/or other information. The information related to shadow zones in the local image may include location, shape, and/or other information for one or more irreducible shadow zones present in the generated image.

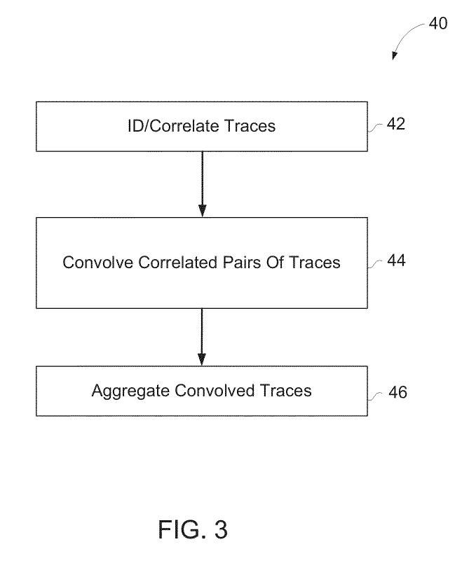

FIG. 3 illustrates a method 40 of generating a local image of a portion of a geologic volume of interest. In some implementations, method 40 may be implemented as operation 32 in method 10 (shown in FIG. 1 and described here). The local images are generated based on Green's functions describing a wavefield between a source location and a set of receiver locations (and/or a seismic source location).

At an operation 42, pairs of corresponding traces in the Green's functions are identified and correlated. This may include identifying and correlating pairs of corresponding traces from the first set of traces and the second set of traces.

At an operation 44, correlated pairs of source traces (traces from the source location to the seismic source location(s)) are convolved with correlated pairs of receiver traces (traces from the source location to the set of receiver locations). These convolutions are performed based on the acquisition parameters of the original seismic acquisition so that receiver and source traces that correspond to receiver and seismic source locations during the original acquisition are convolved, with appropriate phase delays. During this convolution, ray tracing may be used in a supporting role to provide local wave direction within an image subvolume associated with a particular seismic source or receiver position.

At an operation 46, the convolved traces (and/or their associated images) are aggregated to generate an image of the portion of the geologic volume of interest.

Depending on which Green's functions are correlated, various pieces of information are produced. Correlating the Green's function representing the exact velocity field with the Green's function representing an assumed but incorrect velocity field, and then convolving these correlations on the source and receiver ends, one can learn about the sensitivity to velocity error. Likewise, by correlating the exact velocity Green's functions exclusively, but only over a subset of sources and receivers, one can learn about the sensitivity to acquisition variations. Further, by correlating the exact velocity Green's functions exclusively, over the entire source and receiver location space, one can learn about the effect of irreducible shadow zones in the imaging process.

The operations of method 10 (in FIG. 1) and method 40 (in FIG. 3) presented herein are intended to be illustrative. In some embodiments, methods 10 and/or 40 may be accomplished with one or more additional operations not described, and/or without one or more of the operations discussed. Additionally, the order in which the operations of methods 10 and/or 40 are illustrated in FIGS. 1 and/or 4, and described herein is not intended to be limiting.

(28) In some implementations, methods 10 and/or 40 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of methods 10 and/or 40 in response to instructions stored electronically on an electronic storage medium. The one or more processing devices may include one or more devices configured through hardware, firmware, and/or software to be specifically designed for execution of one or more of the operations of methods 10 and/or 40.

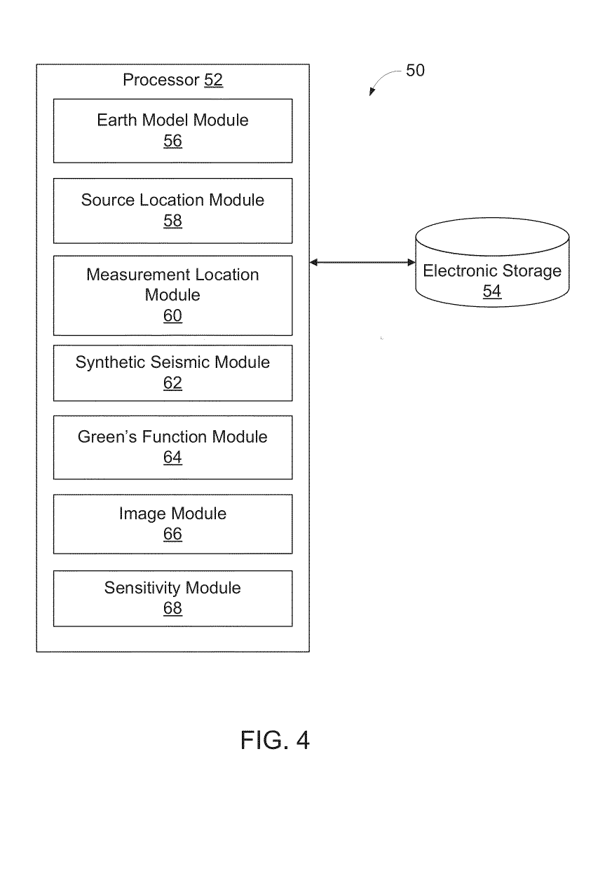

FIG. 4 illustrates a system 50 configured to produce local images of a portion of a geologic volume of interest. In some implementations, system 50 may be configured to perform some or all of the operations of methods 10 and/or 40 shown in FIGS. 1 and/or 3 and described herein. As can be seen in FIG. 4, system 50 may include one or more of at least one processor 52, electronic storage 54, and/or other components.

Processor 52 is configured to execute one or more computer program modules. The computer program modules include one or more of an earth model module 56, a source location module 58, a measurement location module 60, a synthetic seismic module 62, a Green's function module 64, an image module 66, a sensitivity module 68, and/or other modules.

Earth model module 56 is configured to obtain an earth model of a geologic volume of interest. The earth model has been generated based on seismic data acquired during one or more seismic measurements performed in accordance with one or more acquisition parameters. In some implementations, earth model module 56 is configured to provide some or all of the functionality associated with operation 12 of method 10 (shown in FIG. 1 and described herein).

Source location module 58 is configured to obtain a source location in the geologic volume of interest. The source location is positioned based on a position of a portion of the geologic volume of interest for which images are to be generated. In some implementations, source location module is configured to provide some or all of the functionality associated with operations 14 and/or 16 of method 10 (shown in FIG. 1 and described herein).

Measurement location module 60 is configured to obtain locations in or on the geologic volume of interest that were significant in the one or more seismic measurements of the geologic volume of interest. Such locations may include a set of receiver locations, one or more seismic source locations, and/or other locations. In some implementations, measurement location module 60 is configured to provide some or all of the functionality associated with operation 18 of method 10 (shown in FIG. 1 and described herein).

Synthetic seismic module 62 is configured to conduct synthetic seismic acquisition on the earth module that synthesizes a seismic source at the source location and seismic receivers at the set of receiver locations and/or the seismic source location(s). In some implementations, synthetic seismic module 64 is configured to provide some or all of the functionality associated with operation 20 of method 10 (shown in FIG. 1 and described herein).

Green's function module 64 is configured to determine, from the synthetic seismic conducted by synthetic seismic module 62, Green's functions for the seismic wavefield between the source location and the set of receiver locations and/or the seismic source location(s). This may include determining a first set of Green's functions determined from an earth model obtained at operation 12, and/or a second set of Green's functions determined from the earth model with a (potentially) less accurate velocity field. In some implementations, Green's function module 64 is configured to provide some or all of the functionality associated with operation 22 of method 10 (shown in FIG. 1 and described herein).

Image module 66 is configured to generate an image of the portion of the geologic volume of interest that corresponds with the source location. The image is generated from the Green's functions determined by Green's function module 64. In some implementations, image module 66 is configured to provide some or all of the functionality associated with operation 30 of method 10 (shown in FIG. 1 and described herein). This may include some or all of the functionality associated with method 40 (shown in FIG. 3 and described herein).

Sensitivity module 68 is configured to information related to one or more acquisition effects on the generated image, information related to the effects of the velocity model of the geologic volume of interest on the image, or shadow zones in the image. In some implementations, sensitivity module 68 is configured to provide some or all of the functionality associated with operation 32 of method 10 (shown in FIG. 1 and described herein).

(38) Processor 52 is configured to provide information processing capabilities in system 50. As such, processor 52 may include one or more of a digital processor, an analog processor, a digital circuit designed to process information, an analog circuit designed to process information, a state machine, and/or other mechanisms for electronically processing information. Although processor 52 is shown in FIG. 4 as a single entity, this is for illustrative purposes only. In some implementations, processor 52 may include a plurality of processing units. These processing units may be physically located within the same device, or processor 52 may represent processing functionality of a plurality of devices operating in coordination. Processor 52 may be configured to execute modules 56, 58, 60, 62, 64, and/or 66 by software; hardware; firmware; some combination of software, hardware, and/or firmware; and/or other mechanisms for configuring processing capabilities on processor 52.

It should be appreciated that although modules 56, 58, 60, 62, 64, 66, and/or 68 are illustrated in FIG. 4 as being co-located within a single processing unit, in implementations in which processor 52 includes multiple processing units, one or more of modules 56, 58, 60, 62, 64, 66, and/or 68 may be located remotely from the other modules. The description of the functionality provided by the different modules 56, 58, 60, 62, 64, 66, and/or 68 described below is for illustrative purposes, and is not intended to be limiting, as any of modules 56, 58, 60, 62, 64, 66, and/or 68 may provide more or less functionality than is described. For example, one or more of modules 56, 58, 60, 62, 64, 66, and/or 68 may be eliminated, and some or all of its functionality may be provided by other ones of modules 56, 58, 60, 62, 64, 66, and/or 68. As another example, processor 52 may be configured to execute one or more additional modules that may perform some or all of the functionality attributed below to one of modules 56, 58, 60, 62, 64, 66, and/or 68.

Electronic storage 54 comprises non-transient electronic storage media that electronically stores information. The electronic storage media of electronic storage 54 may include one or both of system storage that is provided integrally (i.e., substantially non-removable) with system 50 and/or removable storage that is removably connectable to system 50 via, for example, a port (e.g., a USB port, a firewire port, etc.) or a drive (e.g., a disk drive, etc.). Electronic storage 54 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 54 may include virtual storage resources, such as storage resources provided via a cloud and/or a virtual private network. Electronic storage 54 may store software algorithms, information determined by processor 52, and/or other information that enables system 50 to function properly. Electronic storage 54 may be a separate component within system 50, or electronic storage 54 may be provided integrally with one or more other components of system 50 (e.g., processor 52).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A computer-implemented method of producing local images of a portion of a geologic volume of interest, the method being implemented in a computer system that includes one or more physical processors, the method comprising:
obtaining an earth model of the geologic volume of interest, the earth model having been generated based on seismic data acquired during one or more seismic measurements performed in accordance with one or more acquisition parameters;
obtaining a source location in the geologic volume of interest, wherein a position of the source location in the geologic volume of interest is based on a position in the geologic volume of interest of a portion of the geologic volume of interest for which local images are to be generated;
obtaining a set of receiver locations and a seismic source location in or on the geologic volume of interest, wherein positions of the receiver locations and the seismic source location are toward a surface of the geologic volume of interest from the source location;
conducting synthetic seismic acquisition on the earth model that synthesizes a seismic source at the source location;
determining, from the results of the synthetic seismic acquisition, a first set of Green's functions that describe the seismic wave field propagating from the source location to the set of receiver locations and the seismic source location.

2. The method of claim 1, further comprising generating local images of the portion of the geologic volume of interest from the first set of Green's functions.

3. The method of claim 2, wherein generating the local images of the portion of the geologic volume of interest comprises convolving traces from the first set of Green's functions using the acquisition parameters of the one or more seismic measurements.

4. The method of claim 1, wherein the first set of Green's functions are determined based on the earth model, and wherein the method further comprises determining, from the results of the synthetic seismic acquisition, a second set of Green's functions based on alternative velocity information through the geologic volume of interest.

5. The method of claim 4, further comprising generating local images of the portion of the geologic volume of interest from the first set of Green's functions and the second set of Green's functions.

6. The method of claim 5, further comprising determining, from the local images, information related to one or more of acquisition effects on the generated local images, information related to the effects of a velocity model of the geologic volume of interest on the generated local images, or shadow zones in the generated local images.

7. A system configured to produce local images of a portion of a geologic volume of interest, the system comprising:
one or more processors configured to execute computer program modules, the computer program modules comprising:
an earth model module configured to obtain an earth model of the geologic volume of interest, the earth model having been generated based on seismic data acquired during one or more seismic measurements performed in accordance with one or more acquisition parameters;
a source location module configured to obtain a source location in the geologic volume of interest, wherein a position of the source location in the geologic volume of interest is based on a position in the geologic volume of interest of a portion of the geologic volume of interest for which local images are to be generated;
a measurement location module configured to obtain a set of receiver locations and a seismic source location in or on the geologic volume of interest, wherein positions of the receiver locations and the seismic source location are toward a surface of the geologic volume of interest from the source location;
a synthetic seismic module configured to conduct synthetic seismic acquisition on the earth model that synthesizes a seismic source at the source location;
a Green's function module configured to determine, from the results of the synthetic seismic acquisition, a first set of Green's functions that describe the seismic wave field propagating from the source location to the set of receiver locations and the seismic source location.

8. The system of claim 7, wherein the computer program modules further comprise an image module configured to generate local images of the portion of the geologic volume of interest from the first set of Green's functions.

9. The system of claim 8, wherein the image module is configured such that generating the local images of the portion of the geologic volume of interest comprises convolving traces from the first set of Green's functions using the acquisition parameters of the one or more seismic measurements.

10. The system of claim 7, wherein the Green's function module is configured such that the first set of Green's functions are determined based on the earth model, and wherein the Green's function module is further configured to determine, from the results of the synthetic seismic acquisition, a second set of Green's functions based on alternative velocity information through the geologic volume of interest.

11. The system of claim 10, further comprising an image module configured to generate local images of the portion of the geologic volume of interest from the first set of Green's functions and the second set of Green's functions.

12. The system of claim 10, wherein the computer program modules further comprise a sensitivity module configured to determine, from the local images, information related to one or more of acquisition effects on the generated local images, information related to the effects of a velocity model of the geologic volume of interest on the generated local images, or shadow zones in the generated local images.

13. Non-transient electronic storage media that stores computer readable instructions configured to cause one or more processors to perform a method of producing local images of a portion of a geologic volume of interest, the method comprising:
obtaining an earth model of the geologic volume of interest, the earth model having been generated based on seismic data acquired during one or more seismic measurements performed in accordance with one or more acquisition parameters;
obtaining a source location in the geologic volume of interest, wherein a position of the source location in the geologic volume of interest is based on a position in the geologic volume of interest of a portion of the geologic volume of interest for which local images are to be generated;
obtaining a set of receiver locations and a seismic source location in or on the geologic volume of interest, wherein positions of the receiver locations and the seismic source location are toward a surface of the geologic volume of interest from the source location;
conducting synthetic seismic acquisition on the earth model that synthesizes a seismic source at the source location;
determining, from the results of the synthetic seismic acquisition, a first set of Green's functions that describe the seismic wave field propagating from the source location to the set of receiver locations and the seismic source location.

14. The electronic storage media of claim 13, wherein the method further comprises generating local images of the portion of the geologic volume of interest from the first set of Green's functions.

15. The electronic storage media of claim 14, wherein generating the local images of the portion of the geologic volume of interest comprises convolving traces from the first set of Green's functions using the acquisition parameters of the one or more seismic measurements.

16. The electronic storage of claim 13, wherein the first set of Green's functions are determined based on the earth model, and wherein the method further comprises determining, from the results of the synthetic seismic acquisition, a second set of Green's functions based on alternative velocity information through the geologic volume of interest.

17. The electronic storage of claim 16, wherein the method further comprises determining, from the local images, information related to one or more of acquisition effects on the generated local images, information related to the effects of a velocity model of the geologic volume of interest on the generated local images, or shadow zones in the generated local images.

18. The electronic storage of claim 17, wherein the method further comprises determining, from the local images, information related to one or more of acquisition effects on the generated local images, information related to the effects of a velocity model of the geologic volume of interest on the generated local images, or shadow zones in the generated local images.
